(19) United States
(12) Patent Application Publication
(10) Pub. No.: US 2024/0054206 A1
(43) Pub. Date: Feb. 15, 2024

(54) AUTHENTICATING DEVICES AND COMPONENTS

(71) Applicant: Hewlett-Packard Development Company, L.P., Spring, TX (US)

(72) Inventors: Pierre Louis Robert Belgarric, Bristol (GB); Thalia May Laing, Bristol (GB); Christopher Ian Dalton, Bristol (GB); Joshua Serratelli Schiffman, Washington, DC (US); Jefferson Patrick Ward, Vancouver, WA (US); Stephen Daniel Panshin, Corvallis, OR (US)

(73) Assignee: Hewlett-Packard Development Company, L.P., Spring, TX (US)

(21) Appl. No.: 18/258,254

(22) PCT Filed: Jan. 14, 2021
(86) PCT No.: PCT/US2021/013363

§ 371 Date: Jun. 19, 2023

(51) Int. Cl. G06F 21/44; G06F 21/60; G06F 21/64

(52) U.S. Cl. CPC G06F 21/44; G06F 21/602; G06F 21/64

(57) ABSTRACT

In Example implementations provide a computer program product to authenticate a set of components associated with a device; the components having associated respective shares (s1..sn) of a private key of a private-key/public key pair (sk,pk); the computer program product comprising: instructions to create a signature from the shares (s1..sn) and a message, m, associated with the components; and instructions to generate authentication data comprising at least the signature for transmitting to an authentication server.

### BACKGROUND

An authentic printer cartridge toner manufacturer may manufacture and distribute products that are certified as originating from the manufacturer. Authentication data can be used as proof of origin and proof of authenticity. An auditor can use the authentication data at any point to determine whether or not an apparatus such as a printer is populated with authentic components since inauthentic components might adversely affect the performance of the apparatus.

### BRIEF DESCRIPTION OF THE DRAWINGS

Example implementations will now be described, by way of example, with reference to the accompanying drawings in which:

FIG. 1 shows a system for creating and assigning authentication data to components of a device according to example implementations;

FIG. 2 illustrates a flowchart for creating and assigning authentication data to components of a device according to example implementations FIG. 3 depicts central key and share generation and distributed signing according to example implementations;

FIG. 4 shows distributed key and share generation and distributed signing according to example implementations;

FIG. 5 illustrates a system for authenticating components of a device according to example implementations;

FIG. 6 depicts a flowchart for authenticating components of according to example implementations,

FIG. 7 shows machine-readable storage storing machine-executable instructions for generating authentication data to be used to authenticate components of a device according to example implementations;

FIG. 8 illustrates machine-readable storage storing machine-executable instructions for receiving authentication data for authenticating components of a device according to example implementations; and

FIG. 9 depicts machine-readable storage storing machine-executable instructions for authenticating components of a device according to example implementations.

### DETAILED DESCRIPTION

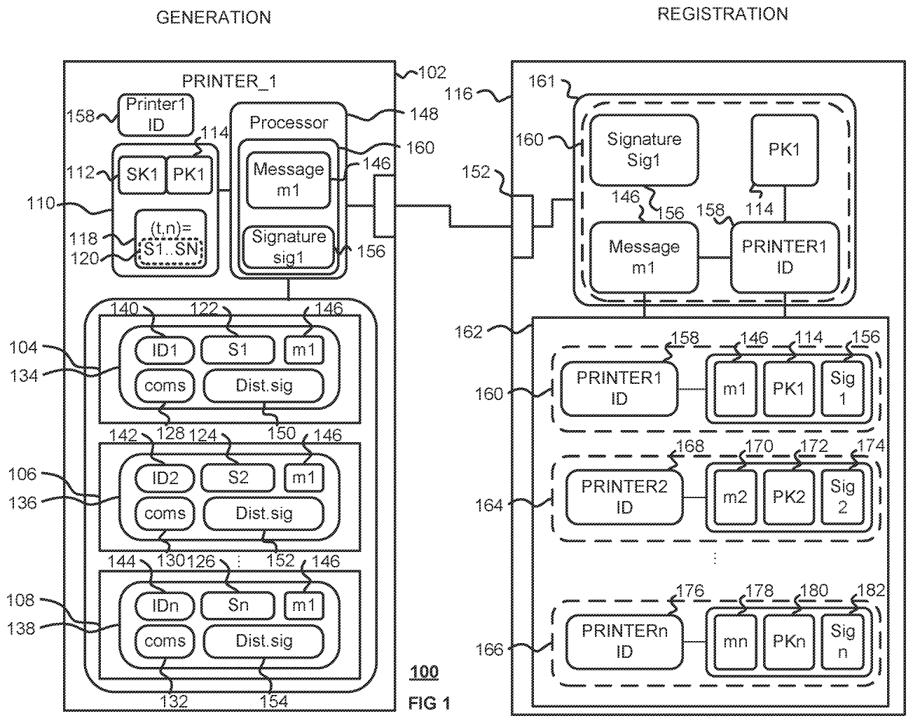

Referring to FIG. 1, there is shown a view 100 of a device 102 comprising a number of components 104 to 108. The device is an example implementation of an apparatus. Example implementations can be realised in which the components are replaceable members. For example, the device 102 can be a printer and the components can be parts of the printer such as, for example, replaceable members. Example implementations can be realised in which the replaceable members are replaceable printer cartridges. The replaceable printer cartridges can comprise liquids or particulates used by the printer. The liquids can comprise inks used in 2D or 3D printing. The liquids can, alternatively or additionally, comprise fluids used in 3D printing. The particulates can comprise toners used in 2D printing or polymer pieces, or other particulates, used in 3D printing.

The example illustrated shows N components 104 to 108. In a printer, N can be determined by the number of colour processes the printer uses. Therefore, for a 6 colour process, that is, N=6, the printer could be populated with magenta, yellow, cyan, red and two black printer cartridges.

Although example implementations have been, and will be, described with reference to the components 104 to 108 being printer cartridges, example implementations are not are limited to such components. Example implementations can be realised in which other components having associated authentication data can be used in addition to, or instead of, the printer cartridges. The other components can comprise, for example, circuitry such as, for example, a trusted platform module, other secure device or any other device comprising authentication data or other identity data or proof of origin data.

The components 104 to 108 form part of the device to support the proper functioning of the device or to avoid the device 102 being otherwise wholly or partially inoperative or not functioning correctly. Example implementations can be realised in which the components 104 to 108 forming part of the device 102 comprises components that are mechanically coupled to the device. The components 104 to 108 forming part of the device can, additionally or alternatively, comprise the components being housed within respective enclosures (not shown) of the device 102. Therefore, for example, it can be appreciated, in example implementations in which the components 104 to 108 are printer cartridges and the device 102 is a printer, the printer cartridges support the proper functioning or operation of the printer since, without one of the components, the printer operation would be limited or otherwise be partially or wholly inoperative. The components 104 to 108 form integral parts of the device 102 as a whole.

The device 102 comprises a secure device 110. The secure device 110 can comprise a trusted platform module. The secure device 110 is arranged to generate a pair of keys that comprises a private key, SK, 112 and a public key, PK, 114 to be used in communicating with an authentication server 116. A private key is an example implementation of a secret key.

The secure device 110 comprises, or has access to, a share generator 118. The share generator 118 is arranged to create shares 120 in the private key 112 for distribution to the components 104 to 108. The secure device 110 is arranged to send respective shares s1 122 to sn 126 to respective components 104 to 108. Each component 104 to 108 comprises a respective communication interface 128 to 132 via which the components 104 to 108 can communicate with other entities of the device 102 such as, for example, the secure device 110 and one another. Therefore, the components 104 to 108 can receive the respective shares s1 122 to sn 126 via respective communication interfaces 128 to 132. The each component 104 to 108, therefore, has an associated respective share. The shares can be associated with the components by storing the shares in respective memories of the components, or having the shares being accessible to the components by storage in some other way that is accessible to respective components. Example implementations can be realised in which the shares are generated by the components, and in which the shares 120 can be subsequently stored in memory of, or accessible to, the components. Accordingly, one, or both, of storing a share in a memory of a component or a component generating a respective share is an example implementation, or are example implementations, of the components having associated respective shares.

If a component is replaced with a newly installed component, example implementations can be realised in which the secure device 110 issues a spare share of the previously generated shares 120 in the private key to such a newly installed component or issues the same share of the private key as was issued to the replaced component. Alternatively, when a component is replaced with a new component, example implementations can be realised in which new shares are generated and issued to all components, and/or in which a new secret-public key pair is generated and shares in the newly generated secret-public key pair are issued to all components.

Example implementations can be realised in which the secure device 110 communicates or otherwise interacts with any installed component to authenticate that component to ensure that only authentic components are issued with shares.

The components 104 to 108 comprise respective component processors 134 to 138. The communication interfaces 128 to 132 can form part of the respective component processors 134 to 138. Each processor 134 to 138 stores, or has access to, respective identification data 140 to 144 that identifies or is otherwise uniquely associated with respective components 104 to 108.

Each component 104 to 108 is also arranged to store, or have access to, a common message, m1, 146. Example implementations can be realised in which the common message, m1, 146 is constructed from the respective identification data 140 to 144 associated with the components 104 to 108. The identification data 140 to 144 can be exchanged between the components 104 to 108 by communication with one another via their respective communication interfaces 128 to 132 or by the intermediary of a processor 148. Example implementations can be realised in which the common message, m1, 146 is a combination of the identification data 140 to 144 of each component 104 to 108. The processor 148 can be associated with or form part of the device 102. The identification data is an example implementation of component identification data.

The component processors 134 to 138 also comprise respective distributed signing units 150 to 154. The distributed signing units 150 to 154 are arranged to collaborate to establish a signature 156 in a distributed manner, that is, via a distributed signing protocol. Example implementations can be realised in which the distributed signing protocol is, for example, threshold distributed signing protocol of a (t,n) threshold signature scheme. Example implementations can be realised using a threshold Schnorr protocol such as, for example, a Flexible Round-Optimised Schnorr Threshold Signatures protocol, or a threshold Elliptic Curve Digital Signature Algorithm. The signature 156 is established using the shares s1 122 to sn 126 and the message m1 146 as part of the distributed signing protocol.

The device 102 also comprises a device identifier (ID) 158 that identifies the device 102.

Authentication data 160 associated with the components 104 to 108 is sent to the authentication server 116. The authentication server 116 comprises a processor 161 for controlling the processing performed by the authentication server 116. The authentication data 160 comprises at least the signature 156. Example implementations can be realised in which the authentication data 160 comprises at least one of the public key 114, the message 146, the device ID 158, the signature 156 or other data associated with, or to be sent to, the authentication server 116 taken jointly and severally in any and all permutations. Example implementations can be realised in which the data associated with the authentication server 116 can, alternatively or additionally, comprise freshness data that can be used to assess or provide an indication of data freshness of the authentication data 160. For example, the freshness data can comprises a Nonce, that is, a number used once, a counter, a time stamp or some other freshness data, that can be generated by the device 102, the authentication server 116, or some other entity, and/or that is issued by the authentication server 116 and returned, by the device 102, as part of the authentication data 160, to provide an indication of the freshness of the authentication data 160. Example implementations can be realised in which the freshness data is generated by the device 102 and is provided as part of the authentication data 160. For example, the device 102 may track the number of times that a given component has been replaced and provide an indication of that number to the authentication server 116. For example, within the context of the components 104 to 108 being printer cartridges, the secure device 110, or processor 148 may track the number of times each cartridge of a given colour process has been replaced and provide that data to the authentication server 116 as part of the authentication data 160. Therefore, the authentication data 160 can comprise at least one of the signature 156, the device ID 158 or freshness data, taken jointly and severally in any and all permutations, without more, if either, or both, of the public key 114 and the message 146 have been previously sent to the authentication server 116.

Generating the authentication data 160 can be responsive to an event. The event can be instigated or generated by the device 102, the authentication server or some other device The event can be detecting a change of one of the components 104 to 108. For example, one of the components 104 to 108 can be replaced with a replacement component. For implementations in which the device 102 is a printer and in which the components 104 to 108 comprise printer cartridges, the event could be installation of a printer cartridge. Additionally, or alternatively, the event can be a message received from the authentication server 116 requesting that the authentication data 160 be established and returned to the authentication server 116 for authenticating.

The authentication server 116 uses the authentication data 160 for either, or both, of registering the authentication data for future authentication actions or assessing the authentication data 160 to establish the status of the components 104 to 108 having previously received authentication data 160 during a registration associated with the device 102.

The authentication server 116 comprises a memory 162 for storing received authentication data 160. The authentication server 116 is arranged to store at least one of device identifiers, associated messages, public keys or signatures 158 taken jointly and severally in any and all permutations. Example implementations store at least one, or both, of the public key or device identifiers. In the illustrated example, the memory 162 is shown as comprising stored authentication data 160, 164, 166 received from a number of devices, including authentication data 160 received from device 102. Each instance of the authentication data 160, 164, 166 comprises at least one, or both, of a respective public key or respective device identifier. In the example implementation shown, each instance of the authentication data can also or alternatively comprise a respective device identifier, a respective public key, a respective message or a respective signature taken jointly and severally in any and all permutations. Therefore, the stored authentication data 160 associated with the device 102 comprises the device ID 158, the message m1 146, the public key pk 114 and the signature sig1 156. The stored authentication data also comprises further authentication data 164 associated with a further device (not shown). The further authentication data 164 comprises a respective device identifier 168, a respective message m2 170, a respective public key pk2 172 and a respective signature sig2 174. The stored authentication data is also depicted as comprising still further authentication data 166 associated with a still further device (not shown). The still further authentication data 166 comprises a respective device identifier 176, a respective message m2 178, a respective public key pk2 180 and a respective signature sig2 182. Although the example implementation has been shown as comprising authentication data 160, 164, 166 associated with three devices, implementations are not limited to three sets of authentication data. Example implementations can be realised in which one set of authentication data or multiple sets of authentication data, each associated with respective devices, can be stored.

The device 102 and the authentication server 116 are operable in either, or both, of a registration mode and an authentication mode, as well as other modes.

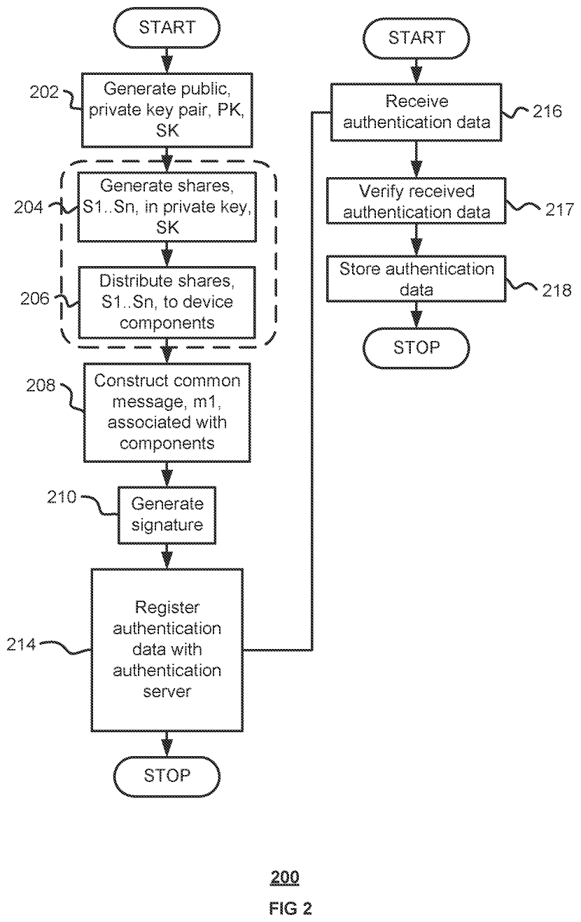

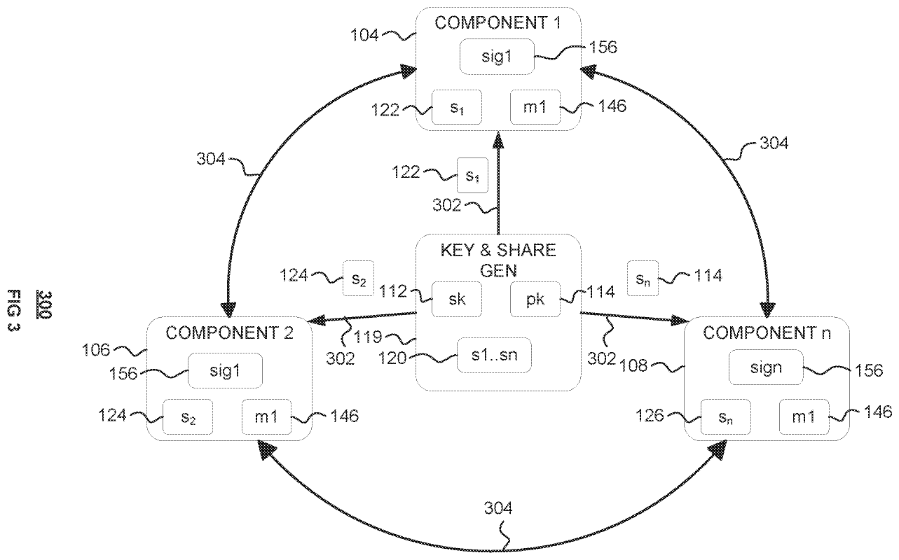

Referring to FIG. 2, there is shown a flowchart 200 of the device 102 and authentication server 116 operating in the registration mode. Registration mode can be entered in response to an event. As indicated above, the event can be instigated by the device 102, the authentication server 116 or some other entity.

At 202, the device 102 generates, or accesses, the private key 112 and the corresponding public key 116. Example implementations use the secure device 108 to generate the private 112 and public 114 keys. At 204, the device 102 generates, or accesses, the shares 120 of the private key 112. The example implementation depicts the secure device 108 as generating, or accessing, the shares 120 of the private key 112. In the example implementation shown in FIG. 1, the shares 120 are centrally created. Therefore, at 206, the centrally created shares 120 are distributed to respective components of the number of components 104 to 108.

The common message, m, 146 is constructed, or accessed, at 208. As described above, the common message, m, 146 can comprise a combination of the component identifiers 140 to 144. The common message, m, 146 can be generated centrally or in a distributed manner. For example, the processor 148 can request each of the components 104 to 108 to supply respective component identifiers 140 to 144 to allow the message 146 to be constructed. The common message 146 generated by the processor 148 can be supplied to the components 104 to 108 following the processor 148 generating that message 146. Alternatively, the common message 146 can be generated in a distributed manner via the components 140 to 108 communicating with one another to exchange respective component identifiers 140 to 144, and combining the component identifiers to generate the common message 146.

At 210, the signature 156 is generated using the shares 120 and the common message 146. Example implementations can be realised in which each component 104 to 108 uses the distributed signing units 150 to 154 to generate the signature 156. In such a distributed signing protocol, the signature 156 can be generated by each of the components 104 to 108, and any of the components 104 to 108 can supply the resulting signature 156 to the processor 148.

The distributed signing units 150 to 154 can implement a threshold distributed signing protocol in which no fewer than t shares of the n shares are used to generate the signature. Example implementations can be realised in which all of the n shares are used to generate the signature 156.

Alternatively, or additionally, rather than example implementations being realised in which the shares 120 are centrally generated, example implementations can be realised in which the shares 120 are generated in a distributed manner using distributed key generation, in which case distributing the shares to the components as per 206 described above could be omitted. The shares 120 can be generated in a distributed manner by the components communicating with one another to generate the private key 112 or the public key 114, or both the private 112 and public 114 keys.

At 214, the authentication data 160 comprising the public key 114, the message 146, the signature 156 or the device ID 158, taken jointly and severally in any and all permutations, are sent to the authentication server 116. Example implementations can be realised in which the sent authentication data comprises at least one, or both, of the public key or the device ID.

The authentication server 116 receives the authentication data 160 at 216 and stores the received authentication data 160 in an accessible, indexed, manner. Prior to storing the received authentication data 160, the authentication server 116 can verify, at 217, the received signature 156 using message 146 and the public key 114 and store the authentication data 160 if the signature 156 is valid at 218. As indicated above, example implementations use the device ID 158 as the index to the stored authentication data. However, example implementations are not limited to using the device ID 158 as such an index. Example implementations can be realised in which at least one of the public key 114, the message 146, the signature or the device ID 158, taken jointly and severally in any and all permutations, is used as, or is used to generate, the index to the stored authentication data 160. Determining whether or not a signature is valid or invalid is an example implementation of determining the verification status of a signature. Similarly, determining whether or not authentication data is valid or authentic, or invalid or inauthentic, are examples of determining the authentication or verification status of the authentication data, that is, making a determination of the authenticity or validity of the authentication data.

Referring to FIG. 3, there is shown a view 300 of centralised key and share generation together with distributed signing according to example implementations. The private 112 and public 114 keys are centrally generated, and the shares 120 of the private key 114 are also centrally established by the device 102, more particularly, by the secure device 110. The shares 120 of the private key 112 are distributed to the components 104 to 108 via respective communications 302.

The components 104 to 108 generate or receive the common message 146, and establish the signature 156 using a distributed signing protocol that uses communications 302 between the components 104 to 108. The distributed signing protocol can comprise a signature generation protocol of a (t,n) threshold signature scheme.

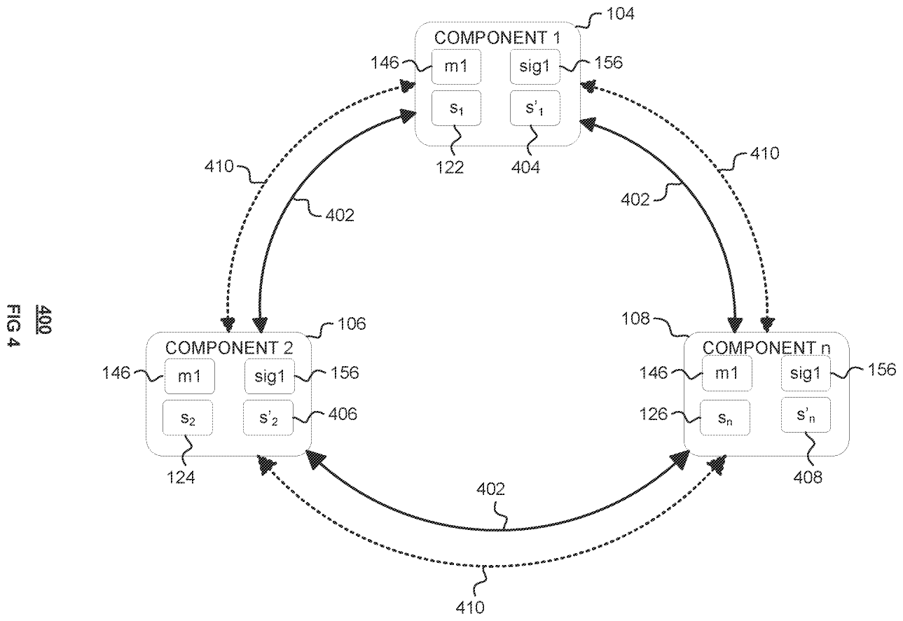

Referring to FIG. 4, there is shown a view 400 of distributed key and share generation together with distributed signature generation according to example implementations. The shares 122 to 126 in the private key 112 are generated in a distributed manner by the components 104 to 108 exchanging messages 402 between themselves. Similarly, shares 404 to 408 in the public key 114 are generated in a distributed manner by the components 104 to 108 cooperating by exchanging messages 410 between themselves.

Additionally, the message 146 can also be generated by the components 104 to 108 in a distributed manner by the components cooperating such as, for example, exchanging component IDs (not shown) 140 to 144 to construct the common message 146.

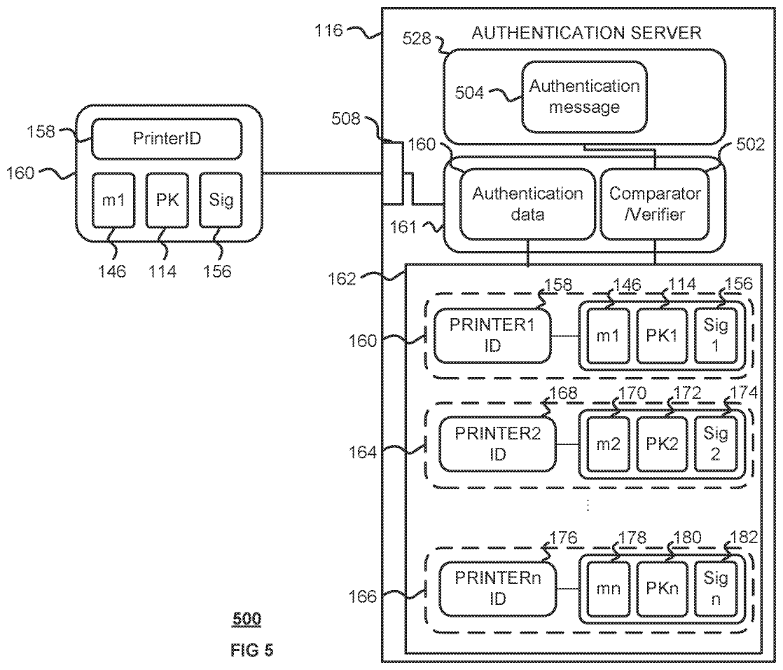

Referring to FIG. 5, there is shown a view 500 of the authentication server 116 receiving the authentication data 160 for authenticating the components 104 to 108. The authentication data 160 can comprise the message 146, the public key 114, the device ID 158 or the signature 156 taken jointly and severally in any and all permutations. Example implementations can be realised in which the authentication data 160 comprises at least one, or both, of the device identifier or the public key. The authentication data 160 is received by the authentication server 116. The processor 161 uses the received authentication data 160 to determine, via a comparator and verifier 502, whether or not there is a match between the received authentication data 160, or data derived from the received authentication data 160, and any of the stored authentication 160, 162, 164. The processor 161 is arranged to determine whether or not there is a match by extracting an index, such as the device identifier, and searching the stored authentication data for a matching index.

The processor 161 is arranged to output a message 504 indicating the validity or otherwise of the received authentication data 160 in response to the comparator and verifier 502 determining whether or not the received authentication data 160 is valid. Determining whether or not the received authentication data 160 is valid or invalid comprises validating the received signature 156 using the stored public key that corresponds to the index, which can be the device ID, associated with the received authentication data 160. If the signature is valid, the authentication is successful and the authentication message 504 will be a positive authentication message indicating that the components 104 to 108 are authentic. Conversely, if the signature is invalid, the authentication is unsuccessful and the authentication message 504 would be a negative authentication message indicating that the components 104 to 108 are inauthentic or, alternatively, the message 504 could be an invitation to commence a registration process to register the received authentication data 160 with the authentication server 116.

Example implementations can be realised in which the device ID 158 of the received authentication data 160 is used as an index to search the stored authentication data 160, 162, 164 when looking fora match. The device ID 158 is used to access the corresponding public key 114 that is used to verify the received signature 156 using the respective message 146; the latter having been previously received or having received as part of the authentication data 160. If the received signature is valid, the components are deemed to be authentic, and the above described positive authentication message is output. If the received signature is invalid, the components are deemed to be inauthentic and the above described negative authentication message is output.

The authentication message 504 can be output on a display 528 of the authentication server 116, or can be output for transmission to a party that has an interest in whether or not the device components 104 to 108 are authentic or otherwise.

It can be appreciated that the signature, having been cooperatively derived from the shares in the private key 112, can only be valid if the shares in the private key 112 held by the components are valid. Therefore, multiple components can be validated or otherwise authenticated using a single signature as opposed to the authentication server 116 validating or authenticating each of the components 104 to 108 individually.

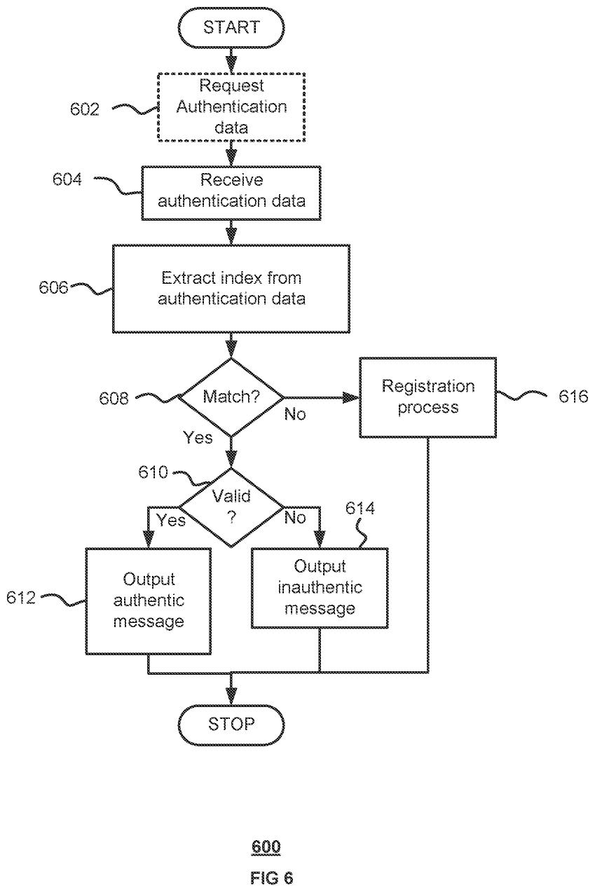

Referring to FIG. 6, there is shown a flowchart 600 for determining whether or not the components 104 to 108 are authentic. At 602 the authentication server 116 can output a message to the device 102 requesting that the device 102 transmits authentication data 160 to the authentication server 116. However, example implementations can also be realised in which the authentication data 160 is received by the authentication server 116 other than in response to a request for such data issued by the authentication server 116. As indicated above, transmitting the authentication data 160 to the authentications server 116 can be responsive to some other event.

Example implementations can be realised in which the message to the device 102 requesting that the device 102 transmits authentication data 160 to the authentication server 116 comprises authentication request data to be used by the device 102 in authenticating the number of components. Example implementations can be realised in which the authentication request data comprises the above freshness data such as, for example, at least one of a time-stamp, counter or a reference to be associated with authenticating the number of components of the device taken jointly and severally in any and all permutations.

At 604, the authentication server 116 receives the authentication data 160. At 606, an index is extracted, or otherwise derived, from the received authentication data 160. The index is used for searching the stored authentication data 160, 162, 164 to determine whether or not any of the stored authentication data corresponds to the received authentication data 160. Example implementations can be realised in which the index is the device ID 158 and the device ID is used to access the corresponding public key 114.

A determination of whether or not there is a match between the index and any of the stored authentication data 160, 162, 164 is made, at 608. If the determination, at 608, is positive, a further determination is made, at 610, of whether or not the signature 156 of the received authentication data 160 is valid based on any stored matching authentication data 160, 162, 164 such as, for example, the public key 114 of any stored authentication data that matches or corresponds to the index and the message 146. If the received signature 156 is determined, at 610, to be valid, a positive authentication message 504 is output at 612. If the received signature 156 is determined, at 610, to be invalid, a negative authentication message 504 is output at 614.

Returning to 608, if the determination is negative, the authentication server 116 can instigate, at 616, a registration process during which the authentication server 116 registers the authentication data 160 for use in future authentications of components associated with that device. Instigating the registration process can comprise exchanging messages with the device to confirm whether or not the authentication server 116 should register the received authentication data 160. If it is determined that registration should take place, the received authentication data 160 is stored in a manner that is accessible via a respective index such as, for example, the device ID 158 corresponding to the device 102.

It will be appreciated that the above described entities such as the device 102 and the authentication server 116 can be realised as hardware, software or a combination of hardware and software, all of which will be referred to herein as “circuitry”. Therefore, it will be appreciated that circuitry as used herein can comprise any of physical electronic circuitry, software (such as machine-readable instructions, machine-executable or processable instructions, referred to herein as machine-instructions), hardware, application specific integrated circuitry (or machine-implemented instructions), or the like, taken jointly or severally in any and all permutations. Such machine-readable instructions, machine-executable or processable instructions, and machine-implemented instructions will be referred to herein as machine-instructions.

Accordingly, example implementations also provide machine-readable storage storing such machine-instructions. The machine-instructions can be executed, processed or interpreted, by a machine or device. The machine or device can comprise one or more processors, or other circuitry, for executing the instructions, implementing the instructions, interpreting the instructions or otherwise processing or giving effect to the instructions.

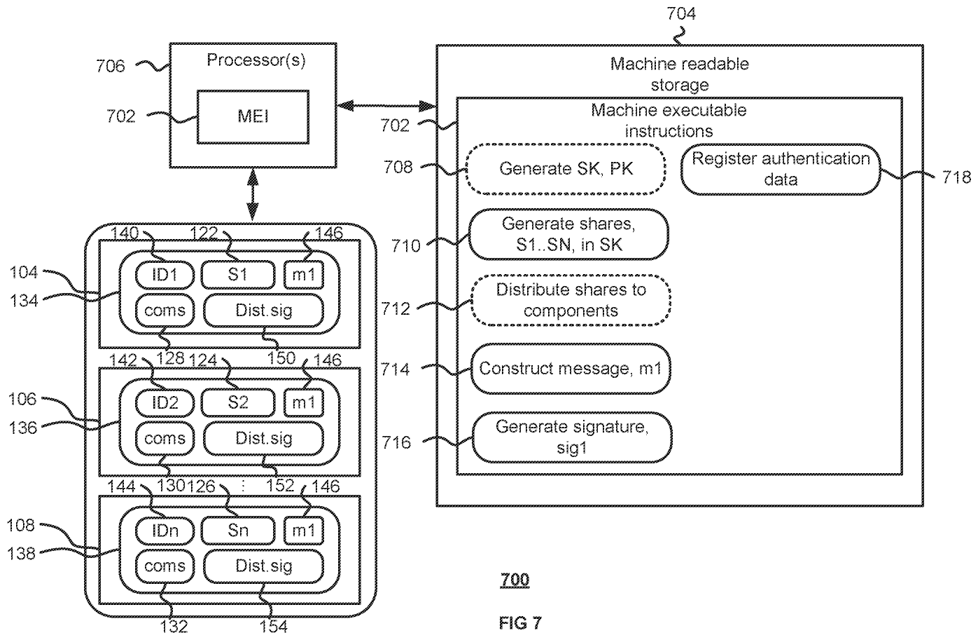

Therefore, referring to FIGS. 7 to 9, there are shown views 700, 800 and 900 of such machine-instructions 702, 802, 902 and respective machine-readable storage 704, 804, 904. The machine-readable storage can be realised using any type of volatile or non-volatile storage such as, for example, memory, a ROM, RAM, EEPROM, or other electrical storage, or magnetic or optical storage or the like. The machine-readable storage can be transitory or non-transitory.

The machine-instructions can be arranged to perform any and all activities, operations, or methods described and/or claimed in this application or to realise any of the entities described and/or claimed in this application such as the operations and entities described with reference to any of the accompanying figures.

Referring to FIG. 7, there is shown a view 700 of such machine-instructions 702 stored on, or implemented in, machine-readable storage 704. The machine-instructions comprise machine-instructions arranged, when processed, to implement any or all aspects of FIGS. 1 to 4 taken jointly and severally in any and all permutations. The machine-instructions 702 can be processed, executed or implemented by a processor 706. The processor 706 is an example of the above described processors 148.

The machine-instructions 702 comprise machine-instructions 708 for generating the above described private key 112 and public key 114 pair. The machine-instructions 708 for generating the key pair 112, 114 are shown in a dashed outline since example implementations can be realised in which the key pair 112, 114 are generated by a central dealer such as, for example, the above described secure device 110. However, example implementations can be realised in which the private key 112 of the key pair 112, 114 is not actually generated since mere shares in that private key 112 are generated as opposed to generating the key per se. It will be appreciated that such mere shares in the private key 112 can be generated in a distributed key or share generation scheme as described herein.

Machine-instructions 710 are provided that generate the shares 120 in the private key 112. In a centralised key generation implementation, machine-instructions 712 are provided to distribute the shares 120, that is, shares 122 to 126, of the private key 112 to respective components 104 to 108.

The common message m1 146 is constructed in response to machine-instructions 714, and the signature 156 is generated by respective machine-instructions 716.

Machine-instructions 718 are provided to send the authentication data 160 to the authentication server 116 for registration or for authentication.

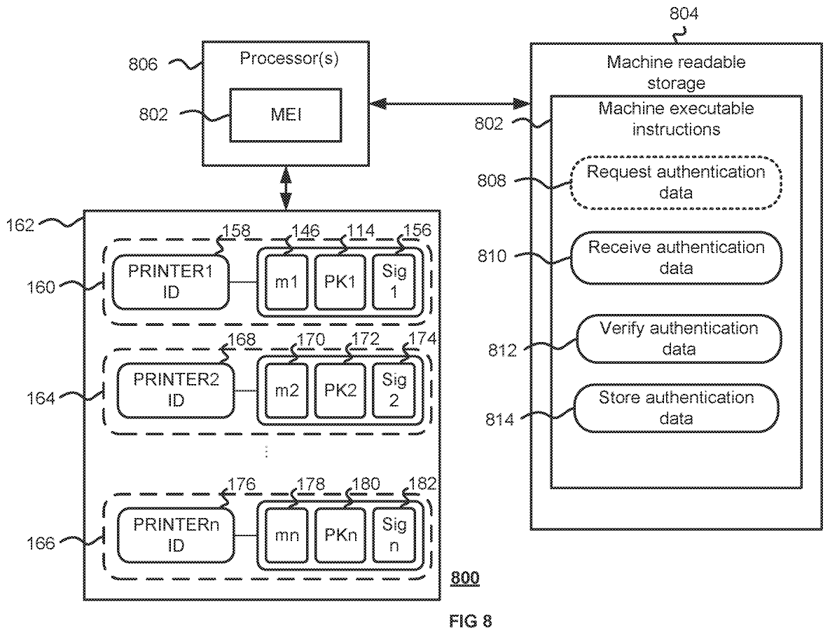

Referring to FIG. 8, there is shown a view 800 of such machine-instructions 802 stored on, or implemented in, machine-readable storage 804. The machine-instructions are arranged, when processed, to implement any or all aspects of FIGS. 1 to 4 taken jointly and severally in any and all permutations. The machine-instructions 802 can be processed, executed or implemented by a processor 806. The processor 806 is an example of the above described processor 161.

The machine-instructions 802 can comprise machine-instructions 808 to request the authentication data 160 from the device 102. The machine-instructions 802 can comprise machine-instructions 810 to receive the authentication data 160 from the device 102. Example implementations can additionally comprise machine-instructions 812 for verifying the received authentication data 160 prior to storage. Machine-instructions 814 are provided to store the received authentication data 160 for authenticating the components 104 to 108 at some future point in time using the stored authentication data 160, 162, 164.

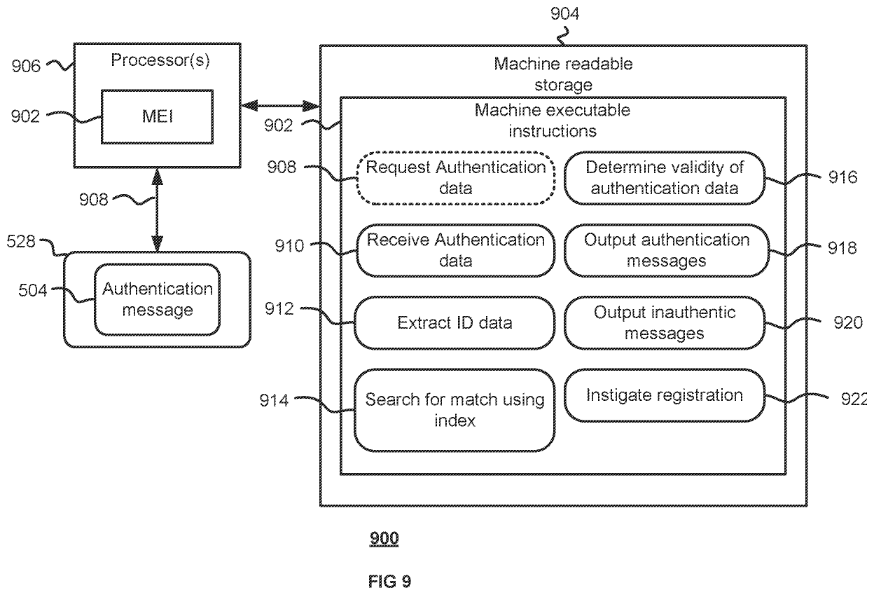

Referring to FIG. 9, there is shown a view 900 of such machine-instructions 902 stored on, or implemented in, machine-readable storage 904. The machine-instructions are arranged, when processed, to implement any or all aspects of FIGS. 5 and 6 taken jointly and severally. The machine-instructions 902 can be processed, executed or implemented by a processor 906. The processor 906 is an example of the above described processor 161.

Machine-instructions 908 can be provided that cause the authentication server 116 to request authentication data from the device 102. Machine-instructions 910 are provided for the authentication server 116 receiving the authentication data 160 from the device 102. An index, such as, for example, the device ID 158, is extracted by respective machine-instructions 912.

Machine-instructions 914 are provided to perform the above described searching for a matching index such as, for example, the matching device ID 158. Machine-instructions 916 are provided to determine whether or not any received authentication data 160, in particular, the received signature 156, is valid or invalid based on the public key 114 associated with the matching index in conjunction with the respective message 146; the message 146 having been received or stored as part of the stored authentication data 160, 164, 166. If the received signature is valid, machine-instructions 918 are provided to output a message 504 to that effect. The message 504 can be a message to the device 102 indicating that the components 104 to 108 are valid or otherwise authentic. If the received signature is invalid, machine-instructions 920 are provided to output a message 504 to that effect. The message 504 can be a message to the device 102 indicating that at least one of the components 104 to 108 is invalid or otherwise inauthentic. If a match between any stored authentication data 160, 162, 164 and the extracted index derived from any received authentication data 160 cannot be identified, machine-instructions 922 are provided to instigate a registration process described above with reference to at least one, or both, of FIGS. 6 and 8.

Although example implementations have been described with reference to the secure device 110 or processor 148 generating the authentication data 104 to 108, example implementations are not limited to such an arrangement. Example implementations can be realised in which the components are pre-populated with authentication data before being installed into the device 102.

Example implementations have been described in which shares 120 of the private key 112 and a corresponding message 146 are associated with a signature 156 that can be used to authenticate the set of installed components 104 to 108. However, example implementations are not limited thereto. Example implementations can be realised in which, rather than the secure device 110 issuing shares 120 in the private key 112, each component 104 to 108 generates a respective BLS private/public key pair; the BLS private key corresponding to a component's “share”. The components use their shares, that is, their BLS private keys, in conjunction with the common message 146, to produce respective BLS signatures. The respective BLS signatures can be combined to produce an aggregated signature that can be sent to the authentication server 116 as part of the authentication data 160, along with a respective aggregated public key that is produced from the BLS public keys. The aggregated BLS signature can be output to the authentication server 116 and used to authenticate the set of components 104 to 108 installed at the device 102.

Example implementations can be realised according to the following clauses:
Clause 1: A computer program product to authenticate a set of components associated with a device; the components having associated respective shares (s1..sn) of a private key of a private-key/public key pair (sk,pk); the computer program product comprising: instructions to create a signature from the shares (s1..sn) and a message, m, associated with the components; and instructions to generate authentication data comprising at least the signature for transmitting to an authentication server. Example implementations can be realised in which creating the signature can result from a distributed, collaborative, effort of the components.
Clause 2: The computer program product of clause 1, comprising instructions to create the message, m, associated with the components.
Clause 3: The computer program product of clause 2, in which the instructions to create the message, m, comprises instructions to create a message associated with at least one of: identification data of at least one component of the set of components, usage data associated with the components, registration data associated with the components, origin data associated with the components, or received data such as a time stamp, counter or reference (authentication request data/challenge data), taken jointly and severally in any and all permutations.
Clause 4: The computer program product of either of clauses 2 and 3, in which the instructions to create the message, m, comprises instructions to access identification data associated with the set of components and deriving a message from that identification data.
Clause 5: The computer program product of any of clauses 1 to 4, in which the instructions to create the signature from the shares comprise instructions to at least one of: create a plurality of signature shares from the message and at least a threshold number, t, of respective shares of the shares (s1..sn), and aggregate signature shares to generate the signature; or derive at least one of the shares or the signature from a distributed protocol implemented by the components, taken jointly and severally in any and all permutations.
Clause 6: The computer program product of any preceding clause, in which the instructions to generate the authentication data comprises instructions to generate authentication data comprising the signature, or the message, or both, for transmitting to the authentication server.
Clause 7: The computer program product of any preceding clause, in which the instructions to generate the authentication data comprises instructions to generate authentication data comprising at least one of: the signature, sig, the message, m, the public key, pk, of the private key/public key pair, and identification data of the device, taken jointly and severally in any and all permutations.
Clause 8: The computer program product of any preceding clause, comprising instructions to create the shares of the private key, sk.
Clause 9: The computer program product of clause 10, in which the instructions to create the shares of the private key, sk, comprise instructions to establish the shares of the private key, sk, using key generation of a (t,n) threshold signature scheme.
Clause 10: The computer program product of any preceding clause, comprising instructions to initiate authenticating the number of components associated with the device in response to an event.
Clause 11: The computer program product of clause 13, comprising instructions to receive the event from the authentication server or instructions to receive the event from an event generator/detector associated with the device.
Clause 12: The computer program product of any preceding clause, in which the components comprise one or more than one printer cartridge and in which the device is a printer.
Clause 13: A computer program product to authenticate a set of components associated with a device; the components having associated respective shares (s1..sn) of a private key of a private-key/public key pair (sk,pk); the computer program product comprising: instructions to receive authentication data comprising at least a signature; the signature having been derived from the shares and a message associated with the components; instructions to verify the signature using at least the public key, pk, and the message associated with the components, and instructions to determine, in response to said verifying, a verification status (valid/invalid) associated with the number of components of the device.
Clause 14: The computer program product of clause 13, comprising instructions to receive the public key, pk, associated with the number of components.
Clause 15: The computer program product of either of clauses 13 and 14, comprising instructions to receive the message, m, associated with the components in advance of receiving the authentication data.
Clause 16: The computer program product of any of clauses 13 to 15, in which the instructions to receive the authentication data comprising at least the signature comprises instructions to receive authentication data comprising at least the signature and the message, m, associated with the components.
Clause 17: The computer program product of any of clauses 13 to 16, comprising instructions to output data to be associated with authenticating the number of components associated with the device.
Clause 18: The computer program product of clause 17, in which the instructions to output data associated with authenticating the number of components associated with the device comprises instructions to generate authentication request data to be used by the device in authenticating the number of components.
Clause 19: The computer program product of clause 18, in which the instructions to generate said authentication request data comprises instructions to generate a time-stamp, counter, or a reference to be associated with authenticating the number of components of the device.
Clause 20: A computer program product to provision a set of components associated with a device; the components having associated respective shares (s1..sn) of a private key of a private-key/public key pair (sk,pk); the computer program product comprising instructions to: access shares (s1..sn) of the private key, sk, associated with respective components of the set of components; and associate the shares (s1..sn) of the private key, sk, with respective components of the set of components.
Clause 21: The computer program product of clause 20, in which the instructions to access the shares of the private key, sk, comprise instructions to create the shares of the private key, sk.
Clause 22: The computer program product of clause 21, in which the instructions to create the shares of the private key, sk, comprise instructions to establish the shares (s1..sn) of the private key, sk, using key generation of a (t,n) threshold signature scheme and instructions to assign at least one of the n shares of the private key, sk, to respective components of each of the set of components.
Clause 23: The computer program product of any of clauses 20 to 22, comprising instructions to generate a message, m, and instructions to provide access to that message to each component of the set of components.
Clause 24: The computer program product of clause 23, in which the instructions to generate the message, m, comprise instructions to obtain component identification data from the components, and instructions to construct the message, m, from the component identification data obtained from the components.
Clause 25: The computer program product of any of clauses 20 to 24, in which the instructions to associate the shares (s1..sn) of the private key, sk, with respective components of the set of components comprise instructions to securely store respective shares in secure storage associated with the set of components.
Clause 26: The computer program product of clause 25, in which the instructions to securely store the respective shares in secure storage associated with the set of components comprises:
instructions to securely store respective shares in respective secure storage associated with respective components of the set of components.
Clause 27: A computer program product to authenticate a set of replaceable printer cartridges installed within a printer; the printer cartridges having associated respective shares (s1..sn) of a private key of a private-key/public key pair (sk,pk); the computer program product comprising instructions to: create a signature from the shares (s1..sn) and a message, m, associated with the printer cartridges; and generate authentication data comprising at least the signature for transmitting to an authentication server.
Clause 28: A replaceable component for a device; the replaceable component comprising a processor and a memory; the replaceable component being one component of a set of components associated with the device; the components storing, in respective memories, respective shares (s1..sn) in a private key of a private-key/public key pair (sk,pk) from which a signature can be derived in conjunction with a message associated with the components.
Clause 29: The replaceable component of clause 28, comprising instructions to at least one of receive or create respective shares of the private key, sk.
Clause 30: The replaceable component of clause 29, in which the instructions to receive or create the respective shares of the private key, sk, comprise instructions to establish the shares (s1..sn) of the private key, sk, using key generation of a (t,n) threshold signature scheme and instructions to assign at least one of the n shares of the private key, sk, to respective components of each of the set of components.
Clause 31: The replaceable component of any of clauses 28 to 30, comprising instructions to generate the message, m, and instructions to provide access to that message to each component of the set of components.
Clause 32: The replaceable component of clause 31, in which the instructions to generate the message, m, comprise instructions to obtain component identification data from the components, and instructions to construct the message, m, from the component identification data obtained from the components.
Clause 33: The replaceable component of any of clauses 31 to 32, comprising instructions to associate the shares (s1..sn) of the private key, sk, with respective components of the set of components comprising instructions to securely store respective shares in secure storage associated with the set of components.
Clause 34: The replaceable component of clause 33, in which the instructions to securely store the respective shares in secure storage associated with the set of components comprises instructions to securely store respective shares in respective secure storage associated with respective components of the set of components.
Clause 35: A method of authenticating a set of components associated with an apparatus; the components having associated respective shares (s1..sn) of a private key of a private-key/public key pair (sk,pk); the method comprising: creating a signature from the shares (s1..sn) and a message, m, associated with the components; and generating authentication data comprising at least the signature for transmitting to an authentication server.
Clause 36: The method of any clause 35, comprising creating the message, m, associated with the components.
Clause 37: The method of clause 36, in which creating the message, m, comprises creating a message associated with at least one of: identification data of at least one component of the set of components, usage data associated with the components, registration data associated with the components, origin data associated with the components, or received, or component generated, data such as a time stamp, counter, reference (authentication request data/challenge data) or freshness data, taken jointly and severally in any and all permutations.
Clause 38: The method of either of clauses 36 and 37, in which creating the message, m, comprises accessing identification data associated with the set of components and deriving a message from that identification data.
Clause 39: The method of any of clauses 35 to 38, in which creating the signature from the shares comprises creating a plurality of signature shares from the message and at least a threshold number, t, of respective shares of the shares (s1..sn), and aggregating signature shares to generate the signature; or deriving at least one of the shares or the signature from a distributed protocol implemented by the components.
Clause 40: The method of any of clauses 35 to 39, in which generating the authentication data comprises generating authentication data comprising the signature and the message for transmitting to the authentication server.
Clause 41: The method of any of clauses 35 to 40, in which generating the authentication data comprises generating authentication data comprising at least one of: the signature, sig, the message, m, the public key, pk, of the private key/public key pair, or identification data of the apparatus, taken jointly and severally in any and all permutations.
Clause 42: The method of any of clauses 35 to 41, comprising creating the shares of the private key, sk.
Clause 43: The method of clause 42, in which creating the shares of the private key, sk, comprises establishing the shares of the private key, sk, using key generation of a (t,n) threshold signature scheme.
Clause 44: The method of any of clauses 35 to 43, comprising initiating authenticating the number of components associated with the apparatus in response to an event.
Clause 45: The method of clause 44, comprising receiving the event from the authentication server or receiving the event from an event generator/detector associated with the apparatus.
Clause 46: The method of any of clauses 35 to 45, in which the components comprise a printer cartridge, or multiple printer cartridges, and in which the apparatus is a printer.
Clause 47: A method of authenticating a set of components associated with an apparatus; the components having associated respective shares (s1..sn) of a private key of a private-key/public key pair (sk,pk); the method comprising: receiving authentication data comprising at least a signature; the signature having been derived from the shares and a message associated with the components; verifying the signature using at least the public key, pk, and the message associated with the components, and determining, in response to said verifying, a verification status (valid/invalid), associated with the number of components of the apparatus.
Clause 48: The method of clause 47, comprising receiving the public key, pk, associated with the number of components.
Clause 49: The method of either of clauses 47 and 48, comprising receiving the message, m, associated with the components in advance of receiving the authentication data.
Clause 50: The method of any of clauses 47 to 49, in which receiving the authentication data comprising at least the signature comprises: receiving authentication data comprising at least the signature and the message, m, associated with the components.
Clause 51: The method of any of clauses 47 to 50, comprising outputting data to be associated with authenticating the number of components of the apparatus.
Clause 52: The method of clause 51, in which outputting data associated with authenticating the number of components of the apparatus comprises generating authentication request data to be used by the apparatus in authenticating the number of components.
Clause 53: The method of clause 52, in which generating said authentication request data comprises generating at least one of a time-stamp, counter, freshness data or a reference, taken jointly and severally in any and all permutations, to be associated with authenticating the number of components of the apparatus.
Clause 54: A method of provisioning a set of components associated with an apparatus; the components having associated respective shares (s1..sn) in a private key of a private-key/public key pair (sk,pk); the method comprising: accessing shares (s1..sn) of the private key, sk, with respective components of the set of components; and associating the shares (s1..sn) of the private key, sk, with respective components of the set of components.
Clause 55: The method of clause 54, in which accessing the shares of the private key, sk, comprises creating the shares of the private key, sk.
Clause 56: The method of clause 55, in which creating the shares of the private key, sk, comprises establishing the shares (s1..sn) of the private key, sk, using key generation of a (t,n) threshold signature scheme and assigning at least one of the n shares of the private key, sk, to respective components of each of the set of components.
Clause 57: The method of any of clauses 54 to 56, comprising generating a message, m, and providing that message to each component of the set of components.
Clause 58: The method of clause 57, in which generating the message, m, comprises obtaining component identification data from the components, and constructing the message, m, from the component identification data obtained from the components.
Clause 59: The method of any of clauses 57 to 58, in which associating the shares (s1..sn) of the private key, sk, with respective components of the set of components comprises securely storing respective shares in secure storage associated with the set of components.
Clause 60: The method of clause 59, in which securely storing the respective shares in secure storage associated with the set of components comprises securely storing respective shares in respective secure storage associated with respective components of the set of components.
Clause 61: A method for authenticating a set of replaceable printer cartridges installed within a printer; the printer cartridges having associated respective shares (s1..sn) in a private key of a private-key/public key pair (sk,pk); the method comprising: creating a signature from the shares (s1..sn) and a message, m, associated with the printer cartridges; and generating authentication data comprising at least the signature for transmitting to an authentication server.
Clause 62: A device, server, system or apparatus comprising a computer program product of any of clauses 1 to 34.
Clause 63: A device, server, system or apparatus arranged to implement a method of any of clauses 35 to 61.

1. A computer program product to authenticate a set of components associated with a device; the components having associated respective shares (s1..sn) of a private key of a private-key/public key pair (sk,pk); the computer program product comprising:
a. instructions to create a signature from the shares (s1..sn) and a message, m, associated with the components; and
b. instructions to generate authentication data comprising at least the signature for transmitting to an authentication server.

2. The computer program product claim 1, comprising instructions to create the message, m, associated with the components.

3. The computer program product of claim 2, in which the instructions to create the message, m, comprise instructions to create a message associated with at least one of:
a. identification data of at least one component of the set of components,
b. usage data associated with the components,
c. registration data associated with the components,
d. origin data associated with the components, or
e. received data such as a time stamp, counter or reference, taken jointly and severally in any and all permutations.

4. The computer program product of claim 2, in which the instructions to create the message, m, comprise instructions to access identification data associated with the set of components and deriving a message from that identification data.

5. The computer program product of claim 1, in which the instructions to create the signature from the shares comprises instructions to:
a. generate the signature using signature generation of a (t,n) threshold signature scheme; or
b. create a plurality of signature shares from the message and at least a threshold number, t, of respective shares of the shares (s1..sn), and
c. aggregate signature shares to generate the signature; or
d. derive at least one of the shares or the signature from a distributed signing protocol implemented by the components.

6. The computer program product of claim 1, in which the instructions to generate the authentication data comprises instruction to generate authentication data comprising the signature and the message for transmitting to the authentication server.

7. The computer program product of claim 1, in which the instructions to generate the authentication data comprises instructions to generate authentication data comprising at least one of:
a. the signature, sig,
b. the message, m,
c. the public key, pk, of the private key/public key pair, and
d. identification data of the device,
taken jointly and severally in any and all permutations.

8. The computer program product of claim 1, comprising instructions to create the shares of the private key, sk.

9. The computer program product of claim 8, in which the instructions to create the shares of the private key, sk, comprise instructions to establish the shares of the private key, sk, using key generation of a (t,n) threshold signature scheme.

10. The computer program product of claim 1, comprising instructions to initiate authenticating the number of components associated with the device in response to an event.

11. The computer program product of claim 10, comprising instructions to receive the event from the authentication server or instructions to receive the event from an event generator/detector associated with the device.

12. A replaceable component for a device; the replaceable component comprising a processor and a memory; the replaceable component being one component of a set of components associated with the device; the components storing, in respective memories, respective shares (s1..sn) in a private key of a private-key/public key pair (sk,pk) from which a signature can be derived in conjunction with a message associated with the components.

13. A computer program product to authenticate a set of components of a device; the components having associated respective shares (s1..sn) of a private key of a private-key/public key pair (sk,pk); the computer program product comprising:
a. instructions to receive authentication data comprising at least a signature; the signature having been derived from the shares and a message associated with the components;
b. instructions to verify the signature using at least the public key, pk, and the message associated with the components,
c. instructions to determine, in response to said verifying, a verification status, valid/v̅a̅l̅i̅d̅, associated with the number of components of the device.

14. The computer program product of claim 13, in which the instructions to receive the authentication data comprising at least the signature comprise instructions to receive authentication data comprising at least one of the signature, the message, m, associated with the components or the public key, pk.

15. The computer program product of claim 14, comprising instructions to output data associated with authenticating the number of components of the device.
